(19) United States
(12) Patent Application Publication
(10) Pub. No.: US 2012/0151330 A1
(43) Pub. Date: Jun. 14, 2012

(54) METHOD AND APPARATUS FOR ENCODING AND DECODING XML DOCUMENTS USING PATH CODE

(75) Inventors: Joo Myoung Seok, Daejeon (KR); Min-Sik Park, Daejeon (KR); Han Kyu Lee, Daejeon (KR); Jin Woo Hong, Daejeon (KR)

(73) Assignee: Electronics and Telecommunications Research Institute, Daejeon (KR)

(21) Appl. No.: 13/129,866

(22) PCT Filed: Oct. 1, 2009
(86) PCT No.: PCT/KR2009/005640

§ 371 Date: Mar. 1, 2012

(30) Foreign Application Priority Data
Oct. 2, 2008 (KR) 10-2008-0097392
Dec. 22, 2008 (KR) 10-2008-0131036

(51) Int. Cl. G06F 17/00

(52) U.S. Cl. 715/242

(57) ABSTRACT

A method and apparatus of encoding and decoding an Extensible Markup Language (XML) document using a path code is provided.

A method of encoding an XML document, the method including: searching the XML document for all element tags and all attributes including character data; extracting an XPath of each of the retrieved element tags and attributes; converting the extracted XPath into a predetermined path code; and expressing an occurrence indicator of each of all element tags included in the converted XPath.

### TECHNICAL FIELD

The present invention relates to a method and apparatus of encoding and decoding an Extensible Markup Language (XML) document using a path code.

### BACKGROUND ART

Large amounts of data may not be transmitted in a terrestrial Digital Multimedia Broadcasting (DMB) environment due to its narrow bandwidth. Also, data in text format such as an Extensible Markup Language (XML) document may not be transmitted. Accordingly, in a traffic information service such as a Transport Protocol Experts Group (TPEG) protocol, XML-based data information may be binary encoded in real time according to a TPEG binary encoding scheme and transmitted to a DMB network.

Currently, a terrestrial DMB protocol, an Electronic Program Guide (EPG) protocol, a TPEG protocol, and the like may include data expressed in an XML document from among metadata transmitted to a domestic terrestrial DMB network. Also, a binary encoding scheme of each of the terrestrial DMB protocol, the EPG protocol, and the TPEG protocol may be standardized. For example, a binary encoding scheme of a TPEG protocol and EPG protocol may use a basic structure of a tag, a length, and data, and encoding may be performed by assigning a tag code to all elements and attributes. Accordingly, when encoding an XML document, a tag code may be assigned to every element written in each layer. In this instance, a tag code may be continuously assigned to an unnecessary element, and thus a compression rate may decrease.

FIG. 1 is a diagram illustrating an example of an XML document in text format. FIG. 2 is a diagram illustrating a basic structure of a binary encoding of an XML document used in a TPEG protocol and an EPG protocol. FIG. 3 is a diagram illustrating a tag code assignment method based on the basic structure of FIG. 2 with respect to the XML document of FIG. 1 in a conventional art.

Referring to FIGS. 1 through 3, the XML document may include an element A, an element B, an element C, and an element D.

According to the tag code assignment method in the conventional art, a tag code may be assigned to each of the element A, the element B, the element C, and the element D. For example, tag codes, “0x02”, “0x03”, “0x04”, and “0x05” may be assigned to each of the element A, the element B, the element C, and the element D.

Also, a content of each of the element A, the element B, the element C, and the element D may be encoded. Although only element D includes character data, the tag code may be assigned to each of the element B and the element C. Accordingly, an unnecessary tag code assignment may be repeated and a compression rate may decrease. Thus, a more efficient tag code assignment method is required.

### DISCLOSURE OF INVENTION

### Technical Goals

An aspect of the present invention provides a method and apparatus of encoding and decoding an Extensible Markup Language (XML) document which may assign a different path code to each XPath of each of all attributes and a portion of elements selected from elements and attributes defined in a schema written in an XML schema, and thereby may reduce an unnecessary tag code assignment and increase a compression rate.

The present invention is not limited to the above-described technical goals.

Also, other technical goals that have not been described above would be appreciated by those skilled in the art.

### Technical Solutions

According to an aspect of the present invention, there is provided a method of assigning a path code to an element and an attribute defined in a schema, the method including: assigning a different path code to each XPath of a portion of elements selected from all elements defined in the schema; and assigning a different path code to each XPath of all attributes defined in the schema. An occurrence indicator of each of all element tags may be expressed based on a number of element nodes located between a start node and an end node of the XPath, and the element tags may be included in the XPath.

According to an aspect of the present invention, there is also provided a method of encoding an XML document, the method including: searching the XML document for all element tags and all attributes including character data; extracting an XPath of each of the retrieved element tags and attributes; and converting the extracted XPath into a predetermined path code based on a path code assignment scheme using an XPath of an element and an attribute. An occurrence indicator of each of all element tags, included in the converted XPath, is expressed based on a number of element nodes located between a start node and an end node of the converted XPath.

According to an aspect of the present invention, there is also provided a method of decoding an XML document encoded, the method including: extracting a path code from the encoded XML document; searching a predetermined path code table for an XPath corresponding to the extracted path code, the path code table being based on a path code assignment scheme using an XPath of an element and an attribute; and selectively restoring the attribute or element tags based on an occurrence indicator of each of the element tags included in the retrieved XPath. Each of the element tags is restored based on a number of element nodes expressed in the occurrence indicator.

### Advantageous Effects

According to an embodiment of the present invention, a method and apparatus of encoding and decoding an Extensible Markup Language (XML) document may assign a different path code to each XPath of each of all attributes and a portion of elements selected from elements and attributes defined in a schema written in an XML schema, and thereby may reduce an unnecessary tag code assignment and increase a compression rate.

### BRIEF DESCRIPTION OF DRAWINGS

FIG. 1 is a diagram illustrating an example of an Extensible Markup Language (XML) document in text format;

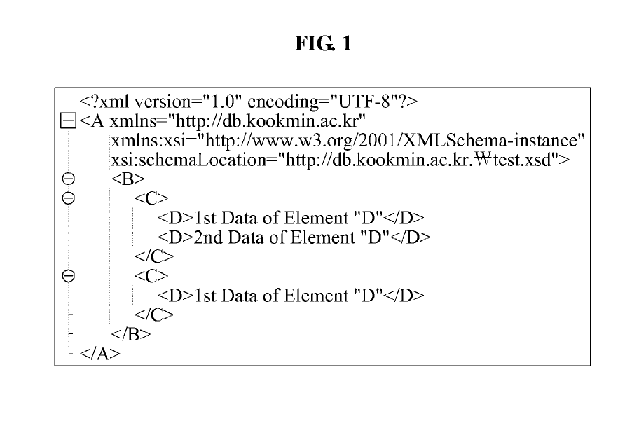

FIG. 2 is a diagram illustrating a basic structure of a binary encoding of an XML document used in a Transport Protocol Experts Group (TPEG) protocol and an Electronic Program Guide (EPG) protocol;

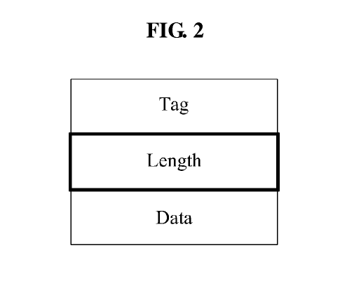

FIG. 3 is a diagram illustrating a tag code assignment method based on the basic structure of FIG. 2 with respect to the XML document of FIG. 1 in a conventional art;

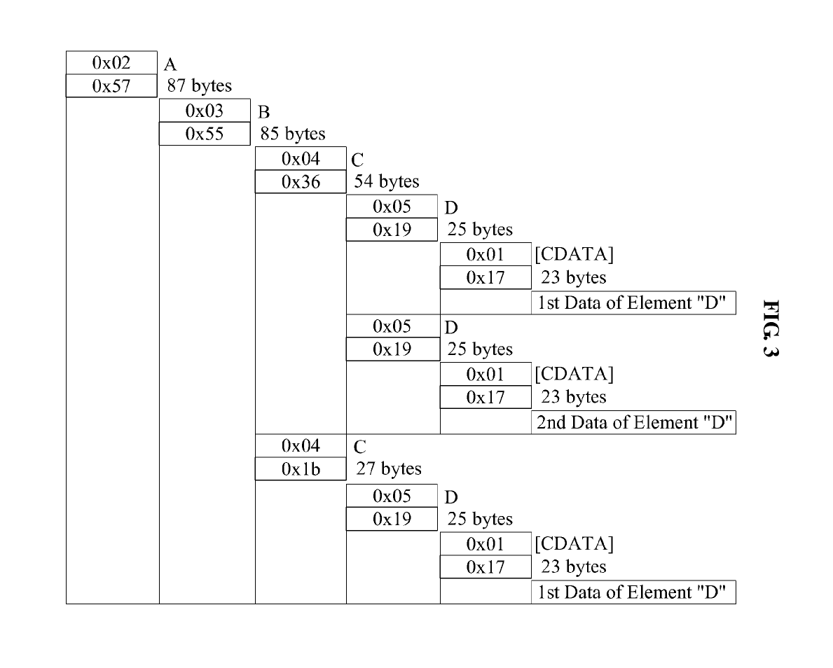

FIG. 4 is a block diagram illustrating a configuration of an apparatus of encoding an XML document according to an embodiment of the present invention;

FIG. 5 is a block diagram illustrating a configuration of an apparatus of decoding an XML document according to an embodiment of the present invention;

FIG. 6 is a diagram illustrating a data structure used when encoding an XML document according to an embodiment of the present invention;

FIG. 7 is a flowchart illustrating a method of assigning a path code according to an embodiment of the present invention;

FIG. 8 is a diagram illustrating an example of a schema written in an XML schema;

FIG. 9 is a graphical diagram illustrating a definition of a schema;

FIG. 10 is a diagram illustrating a path code table of path codes assigned to an XPath of each of an element and an attribute of FIG. 9;

FIG. 11 is a diagram illustrating an example of a Data Encoder Type (DET);

FIG. 12 is a diagram illustrating a length-based encoding rule;

FIG. 13 is a flowchart illustrating a method of encoding an XML document according to an embodiment of the present invention;

FIG. 14 is a flowchart illustrating a method of decoding an XML document according to an embodiment of the present invention;

FIG. 15 is a diagram illustrating an example of a Multiple Occurrence Indicator (MOI) which is an occurrence indicator of all element tags included in an XPath of an element tag or attribute in an XML document; and

FIG. 16 is a diagram illustrating another example of an MOI which is occurrence indicator of all element tags included in an XPath of an element tag or attribute in an XML document.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

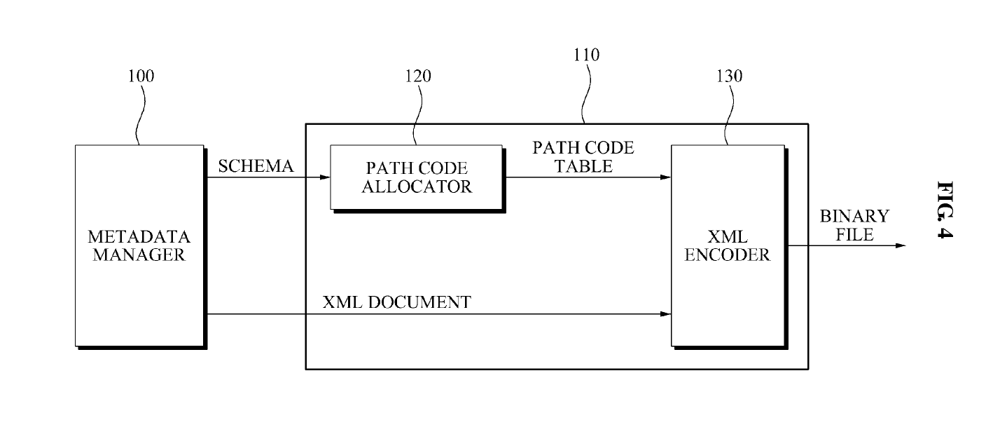

FIG. 4 is a block diagram illustrating a configuration of an apparatus 110 of encoding an Extensible Markup Language (XML) document according to an embodiment of the present invention.

Referring to FIG. 4, the apparatus 110 of encoding an XML document may include a path code allocator 120 and an XML encoder 130.

The path code allocator 120 may receive a schema from a metadata manager 100 and assign a path code to an element and an attribute defined in a schema. That is, the path code allocator 120 may assign a different path code to each XPath of a portion of elements and all attributes, and thereby may generate a path code table.

The XML encoder 130 may receive the XML document from the metadata manager 100, and search the XML document for all element tags and all attributes including character data. Also, the XML encoder 130 may convert an XPath of each of the retrieved element tags and attributes into a path code, defined in the path code table, and perform encoding.

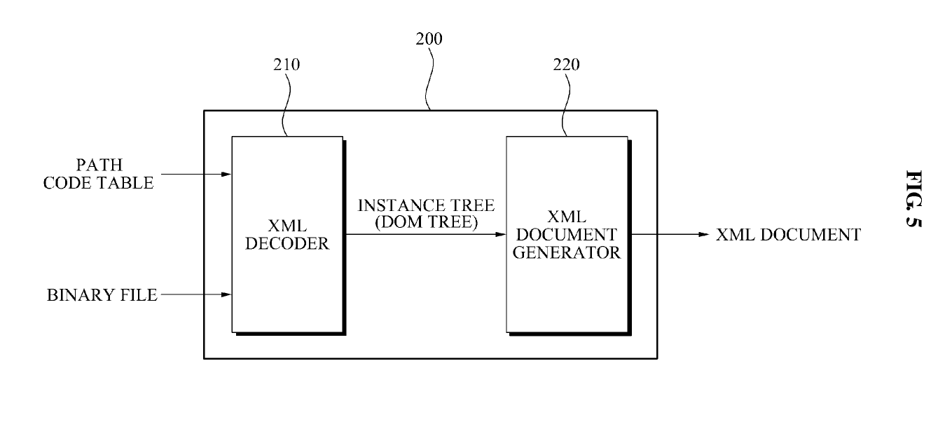

FIG. 5 is a block diagram illustrating a configuration of an apparatus 200 of decoding an XML document according to an embodiment of the present invention.

Referring to FIG. 5, the apparatus 200 of decoding an XML document may include an XML decoder 210 and an XML document generator 220.

The XML decoder 210 may receive a path code table and an encoded XML document. Here, the path code table may be generated based on a path code assignment method using an XPath of an element and an attribute.

The XML decoder 210 may extract a path code from the encoded XML document, and search the received path code table for an XPath corresponding to the extracted path code. The XML decoder 210 may selectively restore an attribute or element tags based on an occurrence indicator of each of the element tags included in the retrieved XPath, and thereby may generate an instance tree.

The XML document generator 220 may generate the XML document from the generated instance tree.

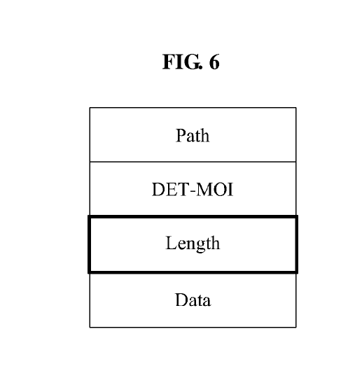

FIG. 6 is a diagram illustrating a data structure used when encoding an XML document according to an embodiment of the present invention.

Referring to FIG. 6, the data structure may include a path, length, data, and Data Encoder Types Multiple Occurrence Indicator (DET-MOI) field. Basically, each of the path, length, and DET-MOI may be represented in one byte.

A path code may be a value assigned to an XPath of an element and an attribute defined in a schema written in an XML schema language. Here, the element may define an element tag expressed in the XML document in the schema. Also, the attribute may declare a property of the element tag and define an entity of the property in the schema.

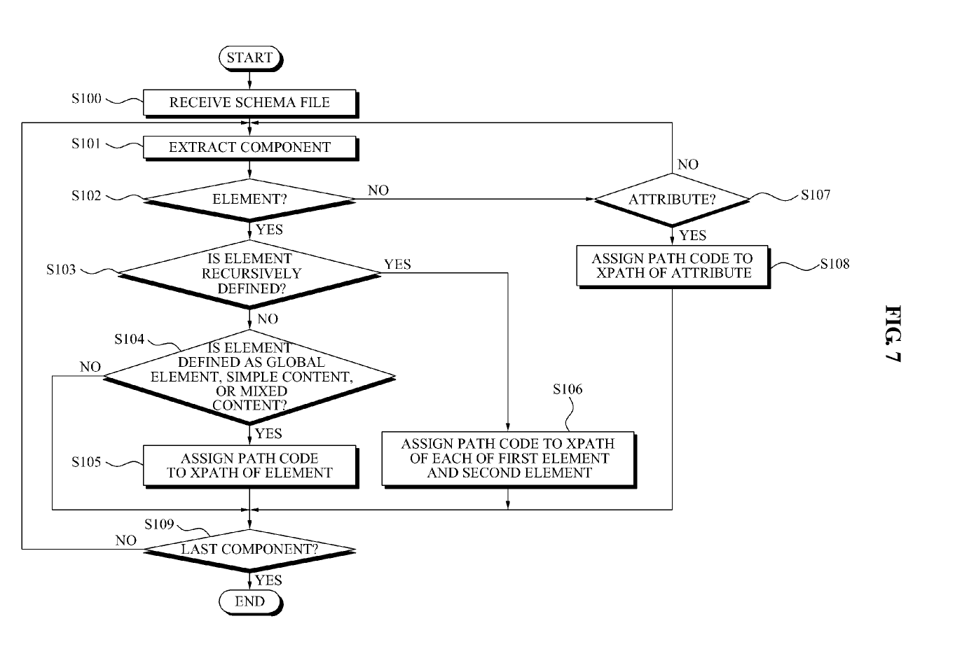

Hereinafter, a method of assigning a path code is described in detail with reference to FIG. 7.

FIG. 7 is a flowchart illustrating a method of assigning a path code according to an embodiment of the present invention.

Referring to FIG. 7, in operation S100, a path code allocator may receive a schema file.

In operation S101, the path code allocator may extract a component defined in a schema.

Here, the component may indicate a factor of the schema, and include an attribute, an element, and the like.

In operation S102, the path code allocator may determine whether the extracted component is an element.

When the extracted component is not the element, the path code allocator may determine whether the component is an attribute in operation S107. In operation S108, when the extracted component is the attribute, the path code allocator may assign a path code to an XPath of the attribute.

Here, when the extracted component is the element, the path code allocator may selectively assign a path code. However, when the extracted component is the attribute, the path code allocator may assign the path code to an XPath of each of all attributes.

In operation S103, when the extracted component is the element, the path code allocator may confirm a definition of the element.

In operation S104, the path code allocator may determine whether the confirmed element is defined as a global element, a simple content, or a mixed content. In operation S105, when the confirmed element is defined as the global element, the simple content, or the mixed content, the path code allocator may assign a different path code to each XPath of the element.

Here, the global element may indicate an element defined as a direct child element of a “schema” root element in the schema.

The simple content may indicate an element including character data.

The path code allocator may assign the path code to only elements defined as a simple content.

Conversely, the path code allocator may not assign the path code to an XPath of an element defined as an element content, that is, an element located between the global element and an element including the character data.

Also, the mixed content may indicate an element simultaneously including the character data and other child elements. The mixed content may be defined by setting a complex-type mixed property, bound to an element in the schema written in an XML schema language, as “true”.

Accordingly, the path code allocator may determine whether the element is defined as the mixed content using the complex-type mixed property value.

In operation S106, when the confirmed element is recursively defined, the path code allocator may assign a different path code to an XPath of each of a first element and a second element. The first element may be an element where the recursion starts and the second element may be an element where the recursion ends.

Here, the element is recursively defined, which indicates that a random element is repeatedly defined as its child element or children element.

After assigning the path code with respect to the extracted schema component, the path code allocator may repeatedly assign a path code with respect to a subsequent schema component, until a last component is extracted from the schema in operation S109.

Hereinafter, the method of assigning a path code is described in greater detail.

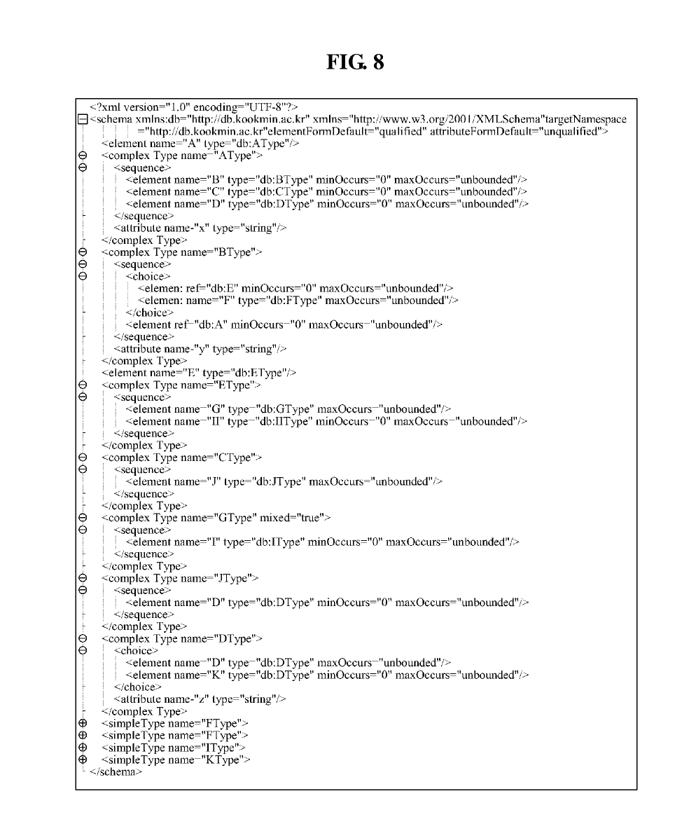

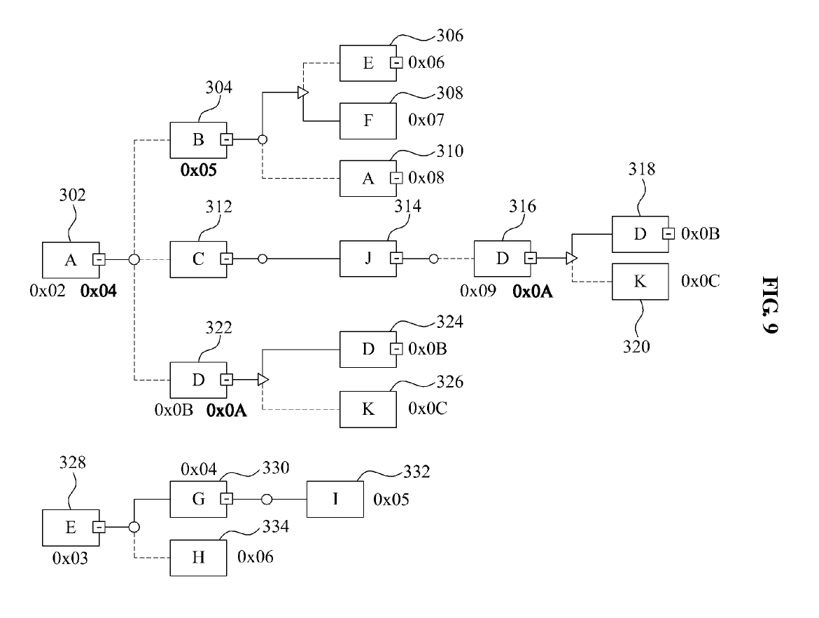

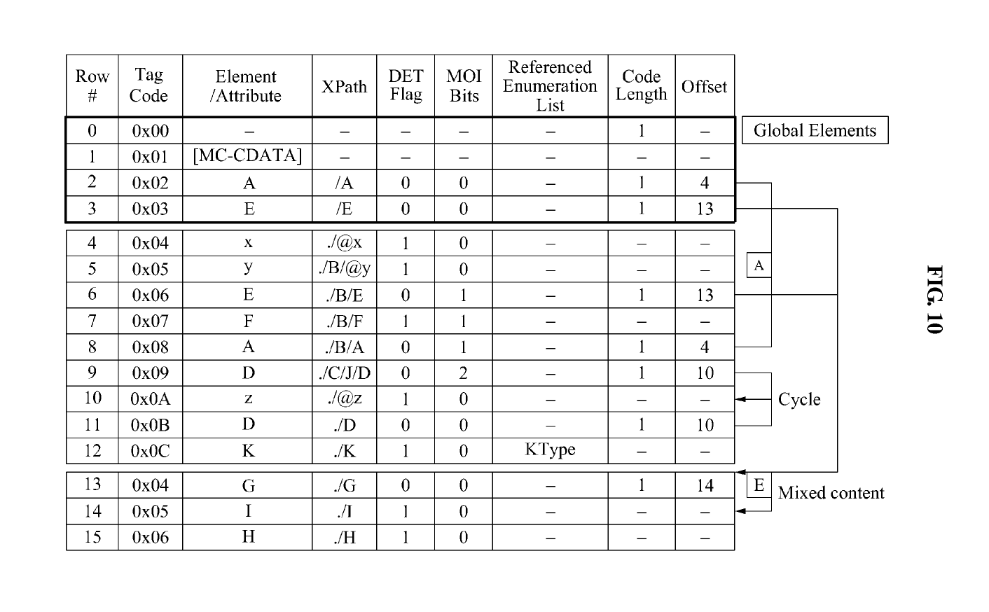

FIG. 8 is a diagram illustrating an example of a schema written in an XML schema. FIG. 9 is a graphical diagram illustrating a definition of the schema of FIG. 8. FIG. 10 is a diagram illustrating a path code table of path codes assigned to an XPath of each of an element and an attribute of FIG. 9.

Referring to FIGS. 8 through 10, an element A 302 and an element E 328 may be global elements. An element F 308, elements K 320 and 326, an element I 332, and an element H 334 may be defined as a simple content including character data. Also, elements D 316, 318, 322, and 324 may be recursively defined elements, and an element G 330 may be an element defined as a mixed content.

A path code allocator may assign a path code “0x02” and a path code “0x03” to an XPath of each of the global elements, the element A 302 and the element E 328. Here, the XPath of each of the element A 302 and the element E 328 are “/A” and “/E”. Also, when each of the element A 302 and the element E 328 is referred to a local element A 310 and a local element E 306, the path code allocator may assign a path code “0x08” and a path code “0x06” to an XPath of each of the referred local element A 310 and local element E 306. Here, the XPath of each of the local element A 310 and the local element E 306 are “./B/A” and “./B/E”. Also, the path code allocator may assign a path code “0x07”, a path code “0x0C”, a path code “0x05” and a path code “0x06” to an XPath of each of the element F 308, the elements K 320 and 326, the element I 332, and the element H 334 including the character data. Here, the XPath of each of the element F 308, the elements K 320 and 326, the element I 332, and the element H 334 are “./B/F”, “./K”, “./I”, and “./H”.

In this instance, a different path code is to be assigned to each of the global elements 302 and 328. Also, a different path code is to be assigned to each of all local elements, and the path code assigned to each of all local elements may be dependent on the global elements 302 and 328. Accordingly, an identical path code may be assigned to local elements defined as a child element of global elements different from each other. That is, the different path code is to be assigned to the XPath of each of the element A 302 and the element E 328. Also, a different path code is to be assigned to the XPath of each of the element A 302 and all children elements of the element A. However, an identical path code “0x06” may be assigned to each of an XPath of the element E 306, which is the child element of the element A 302, and an XPath of the element H 334 which is a child element of the element E 328. Also, when assigning a path code to an XPath, an identical path code may be assigned to an identical XPath. That is, since the elements K 320 and 326 have a same XPath “./K”, the same path code “0x0C” may be assigned.

Sequentially, the path code allocator may assign a path code to an XPath of each of the recursively defined elements D 316, 318, 322, and 324. That is, a different path code may be assigned to an XPath of each of first elements being elements D 316 and 322, and second elements being elements D 318 and 324. The first elements 316 and 322 may be an element where the recursion starts, and the second elements 318 and 324 may be an element where the recursion ends.

For example, the path code allocator may assign a path code “0x09” to an XPath “./C/J/D” of the element D 316 where the recursion starts, and assign a path code “0x0B” to an XPath “./D” of the element D 318 where the recursion ends. Also, the path code allocator may assign the path code “0x0B” to an XPath “./D” of the element D 322 where the recursion starts, and assign the same path code “0x0B” to the XPath “./D” of the element D 324 where the recursion ends. In this instance, the identical path code “0x00x0B” may be assigned to the identical XPath “./D”.

Sequentially, the path code allocator may assign a path code “0x04” to an XPath “./G” of the element G 330 defined as the mixed content. Also, the path code allocator may assign a predetermined value, for example, “0x01”. Here, the predetermined value may indicate that character data of a corresponding element is character data of a mixed content.

Also, the path code allocator may assign a path code to an XPath of each of all attributes defined in the schema. For example, the path code allocator may assign a path code “0x05” to an XPath “./B/@y” of an attribute y of the element B 304, and assign a path code “0x0A” to an XPath “./@z” of an attribute z of the element D 316.

The method described above may assign a path code to an XPath of a portion of elements selected from all elements, without assigning a path code to an XPath of each of the element B 304, an element C 312, and an element J 314 defined as an element content. Accordingly, a compression rate may be improved.

Hereinafter, the DET-MOI is described in detail.

The DET-MOI may include a DET and a MOI.

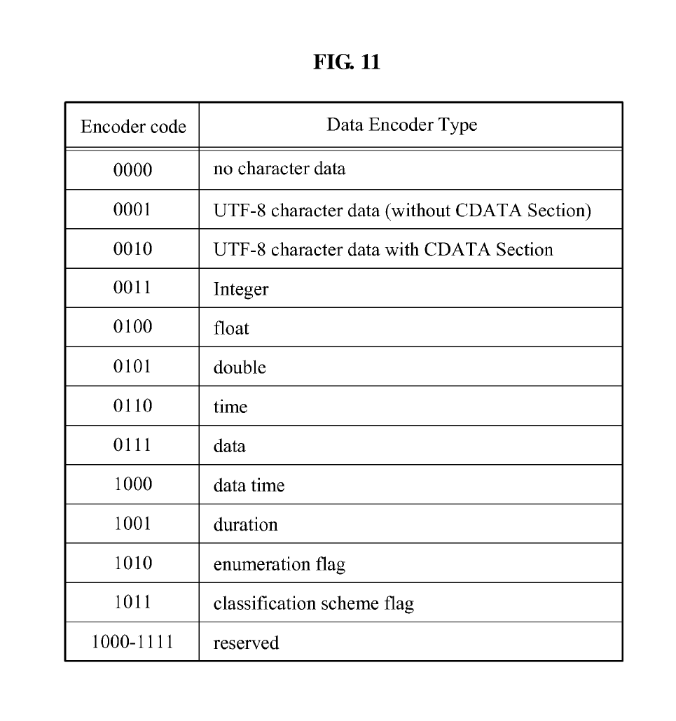

The DET may indicate which encoder encodes an attribute value or character data of an element with respect to each of elements and attributes including character data. The DET may be basically represented using four bits, which is illustrated in FIG. 11 as an example.

The MOI may indicate an occurrence indicator of all element tags included in an XPath of an element tag or an attribute in an XML document. Wherein an occurrence indicator of each of all element tags is expressed based on a number of element nodes located between a start node and an end node of the XPath, the element tags being included in the XPath.

The MOI may sequentially assign one bit to each element node located between a start node and an end node of an XPath. The start node may be a context node, and the end node may indicate a corresponding element tag or attribute.

Specifically, when decoding an element tag or attribute converted into a path code, “1” or “0” may be assigned as each bit value of the MOI, depending on whether an element tag corresponding to each bit is generated. That is, when an element tag corresponding to a particular bit is to be generated, “1” may be assigned. However, when an element tag corresponding to a particular bit is not to be generated, “0” may be assigned.

Sequentially, the MOI may function as a flag of whether to generate each of all element tags included in the XPath when decoding an encoded XML document. In this instance, when an end node in the XPath is an element tag, the corresponding element tag is to be generated all the time. Accordingly, one bit of “1” may not be assigned, and processed as a default “1” when decoding.

Specifically, for an MOI encoding, a cumulative value of element nodes, located from first element node to last element node from among element nodes between the start node and the end node of the XPath, or a cumulative value of element nodes located between the start node and an element node of an element including character data of the XPath, may be encoded by the MOI.

Hereinafter, the ‘length’ of FIG. 6 is described in detail.

The length may indicate a length of data of an attribute and an element tag corresponding to a path code. Here, when a corresponding element tag is defined as an element content, the length may include a length of all bytes of a path, a DET-MOI, a length, and a path corresponding to a lower layer element tag. Also, a length of an element tag including only character data may indicate a length of character data, and a length of an attribute may indicate a length of an attribute value.

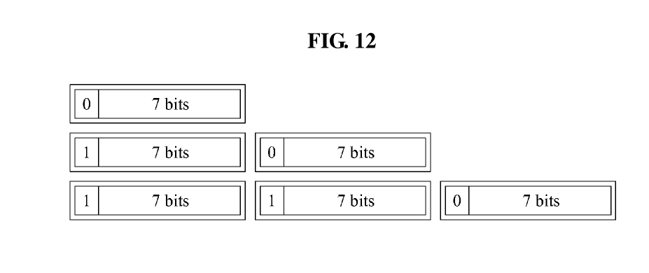

FIG. 12 is a diagram illustrating a length-based encoding rule.

Referring to FIG. 12, when a length is ‘0x00’ to ‘0x7f’, a first bit value may be represented as “0”, and a length may be encoded using one byte. Here, the first bit may function as a flag indicating whether the length is expressed by subsequently including one byte.

However, when the length is beyond ‘0x7f’, the length may be encoded extended to two or three bytes. In this instance, when extended to two bytes, a first bit value of a first byte may be set as “1” and a first bit value of a second byte may be set as “0”. Similarly, when the length is extended to three bytes, a first bit value of each of a first byte and a second byte may be set as “1”, and a first bit value of a third byte may be set as “0” to encode the length.

The ‘data’ of FIG. 6 may indicate data such as character data, and the like.

A data structure used when encoding the XML document may not be limited to the data structure of FIG. 6. Also, a data structure including a path, an MOI, a length, and a data field excluding a DET may be used when encoding the XML document.

Hereinafter, a method of encoding an XML document valid for a schema written in an XML schema language is described.

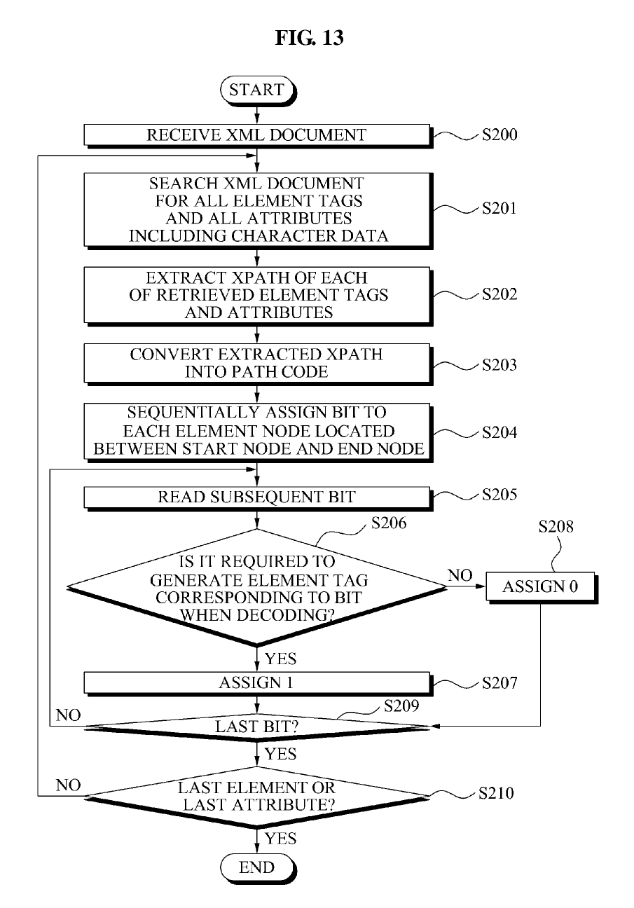

FIG. 13 is a flowchart illustrating a method of encoding an XML document according to an embodiment of the present invention.

Referring to FIG. 13, in operation S200, an XML decoder may receive the XML document.

In operation S201, the XML decoder may search the XML document for an element tag and an attribute including character data. In operation S202, the XML decoder may extract an XPath of the retrieved element tag or attribute. In operation S203, the XML decoder may convert the extracted XPath into a path code.

In operation S204, the XML decoder may sequentially assign one bit to each element node located between a start node and an end node of the XPath to express an MOI which is an occurrence indicator of all element tags included in the XPath.

In operations S205 through S209, when decoding the element tag converted into the path code, the XML decoder may assign “1” to each bit value when an element tag corresponding to a certain bit is to be generated, and assign “0” to each bit value when the element tag corresponding to a certain bit is not to be generated. In operations S210, a path code may be repeatedly assigned to a subsequent element tag or attribute including character data.

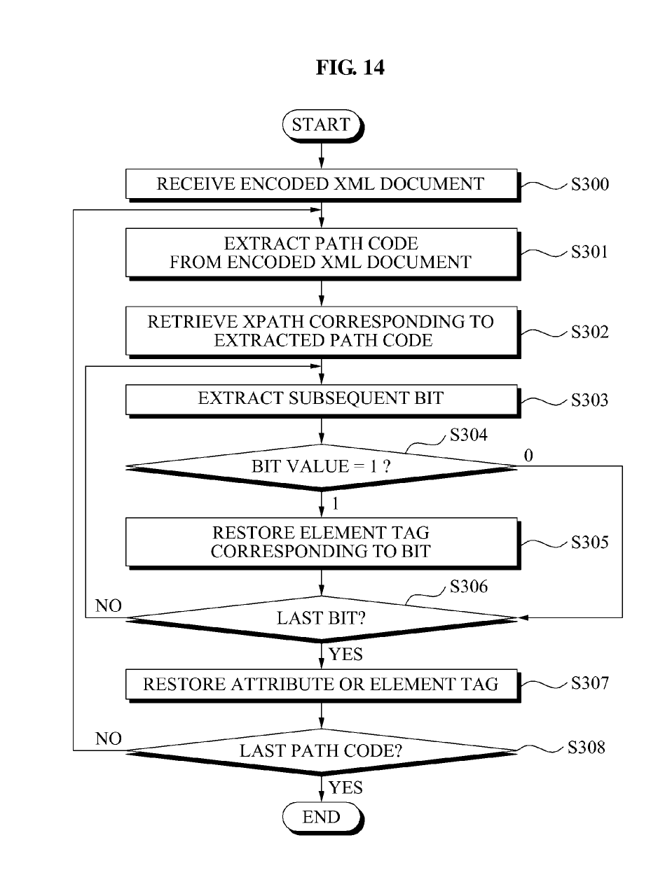

FIG. 14 is a flowchart illustrating a method of decoding an XML document according to an embodiment of the present invention.

Referring to FIG. 14, in operation S300, an XML decoder may receive an encoded XML document.

In operation S301, the XML decoder may extract a path code from the encoded XML document. In operation S302, the XML decoder may retrieve an XPath corresponding to the extracted path code.

The XML decoder may selectively restore an attribute or an element tag based on an MOI which is an occurrence indicator. In this instance, the attribute or an element tag may be included in the retrieved XPath.

In operations S303 through S306, the XML decoder may restore an element tag corresponding to a bit, only when each bit value is “1”, with respect to each bit of the MOI. In operation S307, the XML decoder may restore an element tag or an attribute corresponding to an end node of the retrieved XPath.

In operation S308, the XML decoder may repeatedly perform the above-described decoding process until a last path code is assigned. Accordingly, the decoding process may be completed.

Hereinafter, a method of encoding an XML document using an MOI is described in detail.

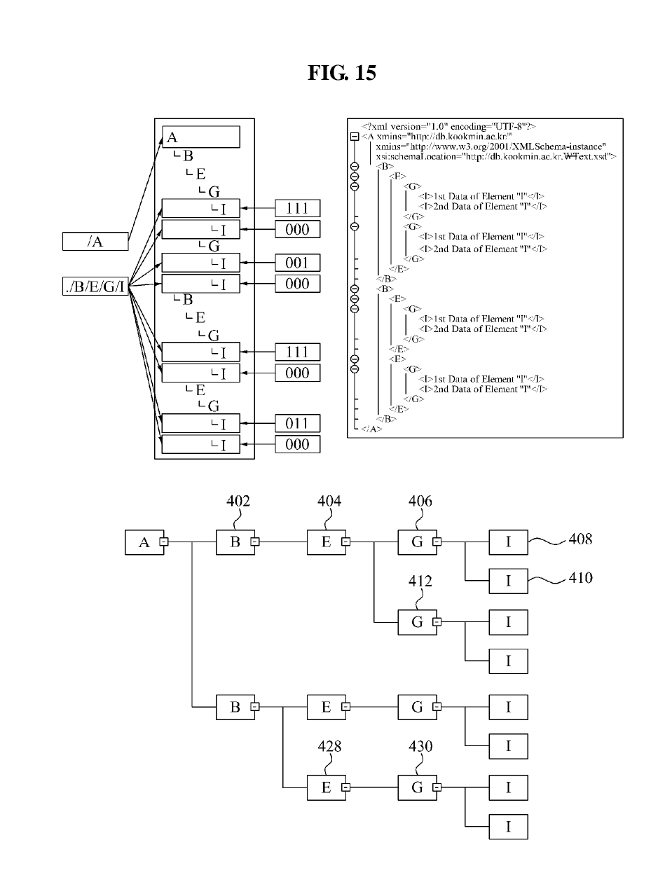

FIG. 15 is a diagram illustrating an example of a MOI which is an occurrence indicator of all element tags included in an XPath of an element tag or attribute in an XML document.

Referring to FIG. 15, an element A may be a global element. Also, elements B, elements E, elements G, and elements I may be children elements of the element A, and form an overlaid structure.

An XPath of the elements I including character data may be “./B/E/G/I”. A method of expressing occurrence indicators of all element tags included in the XPath is described below.

One bit may be sequentially assigned to each element node located between a start node and an end node which is the element I. That is, three bits may be assigned to express an occurrence indicator of each of the element B, the element E, and the element G. Also, when decoding, “1” may be assigned as a bit value when an element tag of each of the element B, the element E, and the element G is to be generated. When an element tag of each of the element B, the element E, and the element G is not to be generated, “0” may be assigned.

For example, each bit of “111” which is an MOI value of a first element tag I may sequentially indicate the element B, the element E, and the element G. Also, since “1” may be assigned as the bit value, an element B 402, an element E 404, and an element G 406 may be generated when decoding.

Sequentially, since each bit value may be assigned as “0” in “000”, which is an MOI value of a second element tag I, all the elements B, the elements E, and the elements G may not be generated when decoding. Accordingly, it may be ascertained that a first element I 408 is a sibling of a second element I 410.

Since an MOI value of a third element tag I is “001”, only element G 412 corresponding to a bit having a value of “1” may be generated. Similarly, the above-described decoding process may be performed using an MOI of a fourth element tag I through a sixth element tag I.

An MOI value of a seventh element tag I is “011”, an element E 428 and an element G 430 corresponding to a bit having a value of “1” may be generated. Similarly, the decoding process may be performed using an MOI of an eighth element tag I.

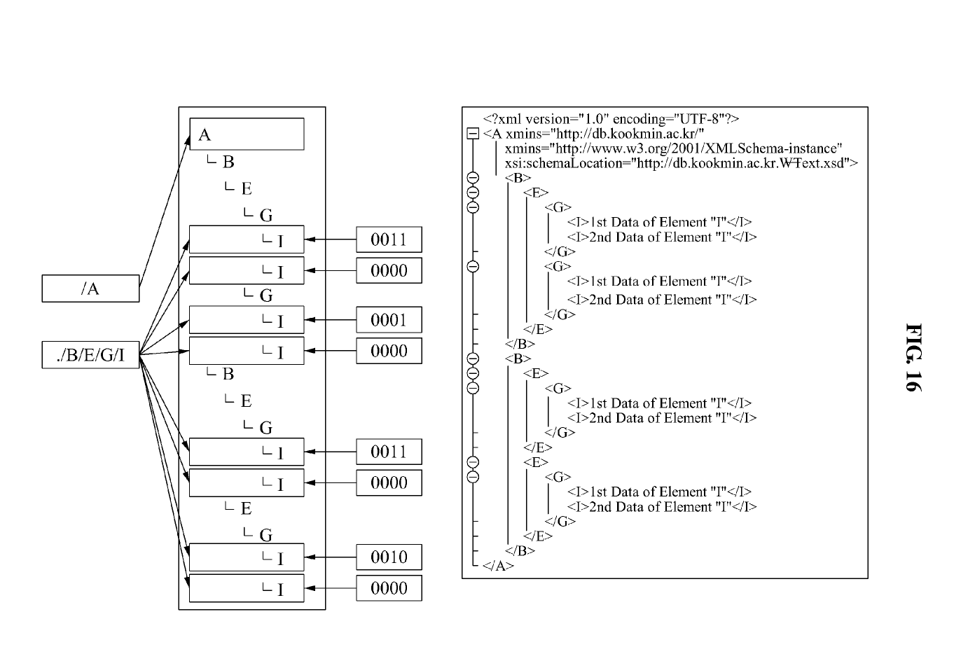

FIG. 16 is a diagram illustrating another example of an MOI which is an occurrence indicator of all element tags included in an XPath of an element tag or an attribute in an XML document.

Referring to FIG. 15, an element A may be a global element. Also, elements B, elements E, elements G, and elements I may be children elements of the element A, and form an overlaid structure.

An XPath of the elements I including character data may be “./B/E/G/I”. A method of expressing occurrence indicators of all element tags included in the XPath is described.

It may be calculated the occurrence indicators of the elements B, the elements E, and the elements G from among element nodes located between a start node and an end node. The end node may be the element I.

For example, “0011” which is an MOI value of a first element tag I may be obtained by encoding a cumulative value “3” of an occurrence of the element B, the element E, and the element G. When decoding, an element B 402, an element E 404, and an element G 406 of FIG. 15 may be generated based on the cumulative value “3”. Here, an occurrence indicator of an upper element based on the cumulative value is to be always calculated from a lower element in an XPath.

Since “0000” which is an MOI value of a second element tag I has no cumulative value, the elements B, the elements E, and the elements G may not be generated when decoding. Accordingly, a first element I 408 may be a sibling of a second element I 410.

Since an MOI value of a third element tag I is “0001”, only an element G 412 of FIG. 15 corresponding to a bottom last element excluding an end node in the XPath may be generated. Similarly, the above-described decoding process may be performed using an MOI of a fourth element tag I through a sixth element tag I.

An MOI value of a seventh element tag I is “0010”, and a cumulative value of an occurrence of an upper element node may be “2”. Accordingly, an element E 428 and an element G 430 of FIG. 15 may be generated. Similarly, the decoding process may be performed using an MOI of an eighth element tag I.

According to the present invention, a method of encoding and decoding an XML document may assign a different occurrence indicator to each XPath of each of a portion of selected elements, and thereby may reduce an unnecessary tag code assignment and increase a compression rate.

The exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of assigning a path code to an element and an attribute defined in a schema written in an Extensible Markup Language (XML) schema language, the method comprising:
assigning a different path code to each XPath of a portion of elements selected from all elements defined in the schema; and
assigning a different path code to each XPath of all attributes defined in the schema,
wherein an occurrence indicator of each of all element tags is expressed based on a number of element nodes located between a start node and an end node of the XPath, the element tags being included in the XPath.

2. The method of claim 1, wherein the number of element nodes corresponds to one of a cumulative value of element nodes, located from first element node to last element node from among element nodes between the start node and the end node of the XPath, or a cumulative value of element nodes located between the start node and an element node of an element including character data of the XPath.

3. The method of claim 1, wherein the assigning of the path code to each of the XPaths of the portion of elements comprises:
confirming whether each of all the elements is defined as a global element; and
assigning a different path code to an XPath of the global element when each of all the elements is defined as the global element.

4. The method of claim 1, wherein the assigning of the path code to each of the XPaths of the portion of elements comprises:
confirming whether each of all the elements is defined as a simple content including character data; and
assigning a different path code to an XPath of each of all the elements when each of all the elements is defined as the simple content.

5. The method of claim 1, wherein the assigning of the path code to each of the XPaths of the portion of elements comprises:
confirming whether each of all the elements is recursively defined; and
assigning a different path code to an XPath of each of a first element and a second element when each of all the elements is recursively defined, the first element being an element where the recursion starts and the second element being an element where the recursion ends.

6. The method of claim 1, wherein the assigning of the path code to each of the XPaths of the portion of elements comprises:
confirming whether each of all the elements is defined as a mixed content; and
assigning a different path code to an XPath of each of all the elements when each of all the elements is defined as the mixed content.

7. A method of encoding an XML document valid for a schema written in an XML schema language, the method comprising:
searching the XML document for all element tags and all attributes including character data;
extracting an XPath of each of the retrieved element tags and attributes; and
converting the extracted XPath into a predetermined path code based on a path code assignment scheme using an XPath of an element and an attribute,
wherein an occurrence indicator of each of all element tags, included in the converted XPath, is expressed based on a number of element nodes located between a start node and an end node of the converted XPath.

8. The method of claim 7, wherein the number of element nodes corresponds to one of a cumulative value of element nodes, located from first element node to last element node from among element nodes between the start node and the end node of the XPath, or a cumulative value of element nodes located between the start node and an element node of an element including character data of the XPath.

9. The method of claim 7, wherein the path code assignment scheme using the XPath of the element and the attribute comprises:
assigning a different path code to each XPath of a portion of elements selected from all elements defined in the schema; and
assigning a different path code to each XPath of all attributes defined in the schema.

10. A method of decoding an XML document encoded based on a path code, the method comprising:
extracting a path code from the encoded XML document;
searching a predetermined path code table for an XPath corresponding to the extracted path code, the path code table being based on a path code assignment scheme using an XPath of an element and an attribute; and
selectively restoring the attribute or element tags based on an occurrence indicator of each of the element tags included in the retrieved XPath,
wherein each of the element tags is restored based on a number of element nodes expressed in the occurrence indicator.

11. The method of claim 10, wherein the number of element nodes corresponds to one of a cumulative value of element nodes, located from first element node to last element node from among element nodes between the start node and the end node of the XPath, or a cumulative value of element nodes located between the start node and an element node of an element including character data of the XPath.

12. An apparatus of encoding an XML document valid for a schema written in an XML schema language, the apparatus comprising:
a path code allocator to assign a path code to an element and an attribute, defined in the schema, based on a path code assignment scheme using an XPath of the element and the attribute, and to generate a path code table; and
an XML encoder to search the XML document for all element tags and all attributes including character data, and convert an XPath of each of the retrieved element tags and attributes into a predetermined path code defined in the path code table to encode,
wherein an occurrence indicator of each of all element tags, included in the converted XPath, is expressed based on a number of element nodes located between a start node and an end node of the converted XPath.

13. An apparatus of decoding an XML document encoded based on a path code, the apparatus comprising:
an XML decoder to search a predetermined path code table for an XPath corresponding to an extracted path code, selectively restore the attribute or element tags based on an occurrence indicator of each of the element tags included in the retrieved XPath, and generate an instance tree, the path code table being based on a path code assignment scheme using an XPath of an element and an attribute; and
an XML document generator to generate an XML document from the generated instance tree,
wherein each of the element tags is restored based on a number of element nodes expressed in the occurrence indicator.
